(19) United States
(12) Patent Application Publication
(10) Pub. No.: US 2012/0163474 A1
(43) Pub. Date: Jun. 28, 2012

(54) SIGNAL TRANSCEIVING APPARATUS WITH POWER PROVIDER

(76) Inventor: Chun-Yuan Lai, Kaohsiung City (TW)

(21) Appl. No.: 12/979,364

(22) Filed: Dec. 28, 2010

(51) Int. Cl. H04N 11/02; H02J 1/00; H04B 1/38

(52) U.S. Cl. 375/240.25; 455/73; 307/75

(57) ABSTRACT

A signal transceiving apparatus with a power provider, which comprises: a power receiving interface, for receiving a first power; a power output interface, for outputting a second power; a signal transferring apparatus, for receiving a third power, receiving input data and for transferring the input data to an output data matching a target electronic apparatus spec; and a signal output interface, for outputting the output data to the target electronic apparatus; wherein the signal transforming apparatus does not provide power to the target electronic apparatus, where the second power, the third power are generated according to the first power.

### BACKGROUND OF THE INVENTION

1. Field of the Invention

The present invention relates to a signal transceiving apparatus, and particularly relates to a signal transceiving apparatus including a power provider.

2. Description of the Prior Art

Conventionally, there are different transmitting formats for signal transmitting and power supplying of an electronic apparatuses. For example, some electronic apparatuses can be connected to each other, such as independent front stages and back stages of a signal amplifier, or signal converters and signal receiving apparatuses. Such apparatus may utilized battery therein to provide power, or utilizes a connection interface with power supplying to provide power, for example, a USB interface. In such apparatus, only a connection line is needed for signal and power transmitting for the apparatus, such that the connection line assignment can be simple and convenient. However, the apparatuses that do not carry power therein such as a projector or a computer, always has an independent power converter, such that the connection of signals and power must be considered in the connection line arrangement. In such structure, the independent voltage power converter must occupy a socket, and another socket signal receiving is needed for signal receiving. Such arrangement may causes inconvenience.

### SUMMARY OF THE INVENTION

Accordingly, one objective of the present invention is to provide a signal transceiving apparatus with a power provider, to provide power and desired data to the electronic apparatus, via a single apparatus.

One embodiment of the present invention provides a signal transceiving apparatus with a power provider, which comprises: a power receiving interface, for receiving a first power; a power output interface, for outputting a second power; a signal transferring apparatus, for receiving a third power, receiving input data and for transferring the input data to an output data matching a target electronic apparatus spec; and a signal output interface, for outputting the output data to the target electronic apparatus; wherein the signal transforming apparatus does not provide power to the target electronic apparatus, where the second power, the third power are generated according to the first power.

Another embodiment of the present invention provides a signal transceiving apparatus with a power provider, which comprises a first body and a second body. The first body includes: a power receiving interface, for receiving a first power; and a power output interface, for outputting a second power. The second body, receives a third power, receives a input data and transfers the input data to an output data matching a target electronic apparatus spec. The second body includes a signal output interface, for outputting the output data to the target electronic apparatus. The second body does not provide power to the target electronic apparatus, where the second power, the third power are generated according to the first power.

Via above mentioned embodiments, power and data can be provided to the target electronic apparatus via only one apparatus, such that the target electronic apparatus needs no extra power providers and signal transmission lines. By this way the convenience for carrying and fabricating largely improves.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a signal transceiving apparatus according to one embodiment of the present application.

FIG. 2 is an exemplary structure of the signal transceiving apparatus shown in FIG. 1.

FIG. 3 is a schematic diagram illustrating appearance of the signal transceiving apparatus and the target electronic apparatus shown in FIG. 2.

FIG. 4 is a schematic diagram illustrating appearance of the signal transceiving apparatus shown in FIG. 2.

FIG. 5 is a schematic diagram illustrating how to utilize the flexible part to control the signal transceiving apparatus to present different angles.

FIG. 6 is a variation example for the embodiment shown in FIGS. 3 and 4.

FIG. 7 is a variation example for the embodiment shown in FIG. 2.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

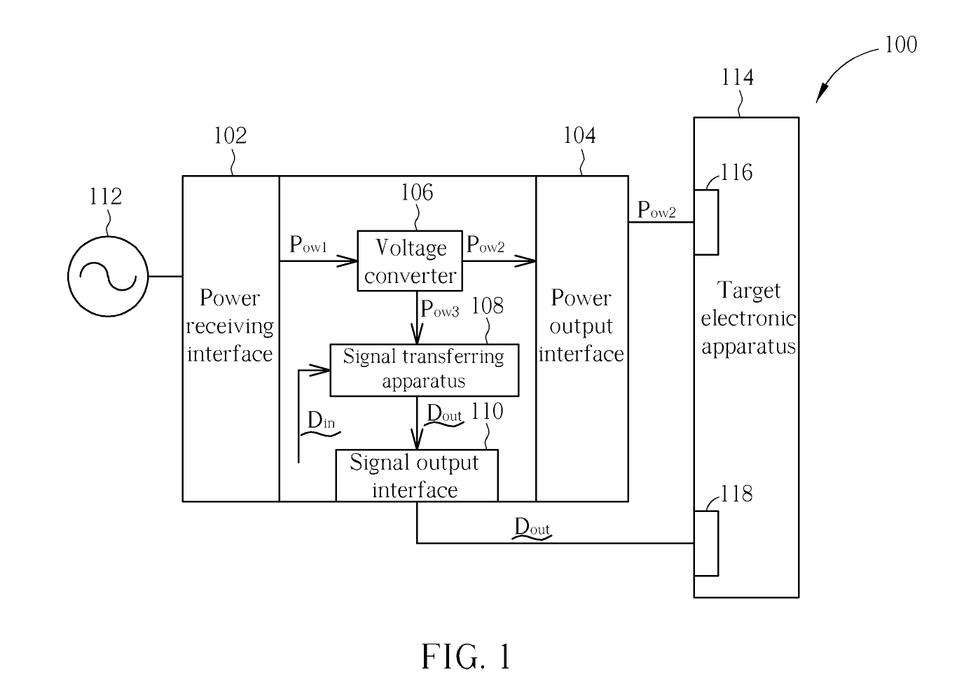

FIG. 1 illustrates a signal transceiving apparatus 100 according to one embodiment of the present application. As shown in FIG. 1, the signal transceiving apparatus 100 includes a power receiving interface 102, a power output interface 104, a voltage converter 106, a signal transferring apparatus 108 and a signal output interface 110. The power receiving interface 102 receives power P_{owe1} from the power source 112. The power output interface 104 receives and outputs the power P_{owe2} to the target apparatus 114. The signal transferring apparatus 108 receives a power Pow3, receives input data Dᵢₙ and transfers the input data Dᵢₙ to an output data Dₒᵤₜ matching a spec of the target electronic apparatus 114. The output data Dₒᵤₜ can be audio and video data. The second power Pow2 and the third power Pow3 can be generated according to the first power P_{ow1}. In other embodiments, the voltage converter 106 can directly by pass the power Pow1 to directly generate the powers Pow2 or Pow3. If the powers Pow2 or Pow3 can be generated via by-passing the power Pow1, the voltage converter 106 can be omitted. The signal output interface 110 is utilized to output the output data Dₒᵤₜ to the target electronic apparatus 114. The target electronic apparatus 114 always include a power receiving interface 116 and a signal receiving interface 118, to respectively receive the power Pow2 and the output data Dₒᵤₜ. It should be noted that the signal transferring apparatus 108 does not provide power to the target electronic apparatus 114. That is, the voltage or spec of the output data Dₒᵤₜ provided from the signal transferring apparatus 108 to the target electronic apparatus 114 is not qualified enough to be the power. In another embodiment, the signal transceiving apparatus 100 does not receive any power from the target electronic apparatus 114.

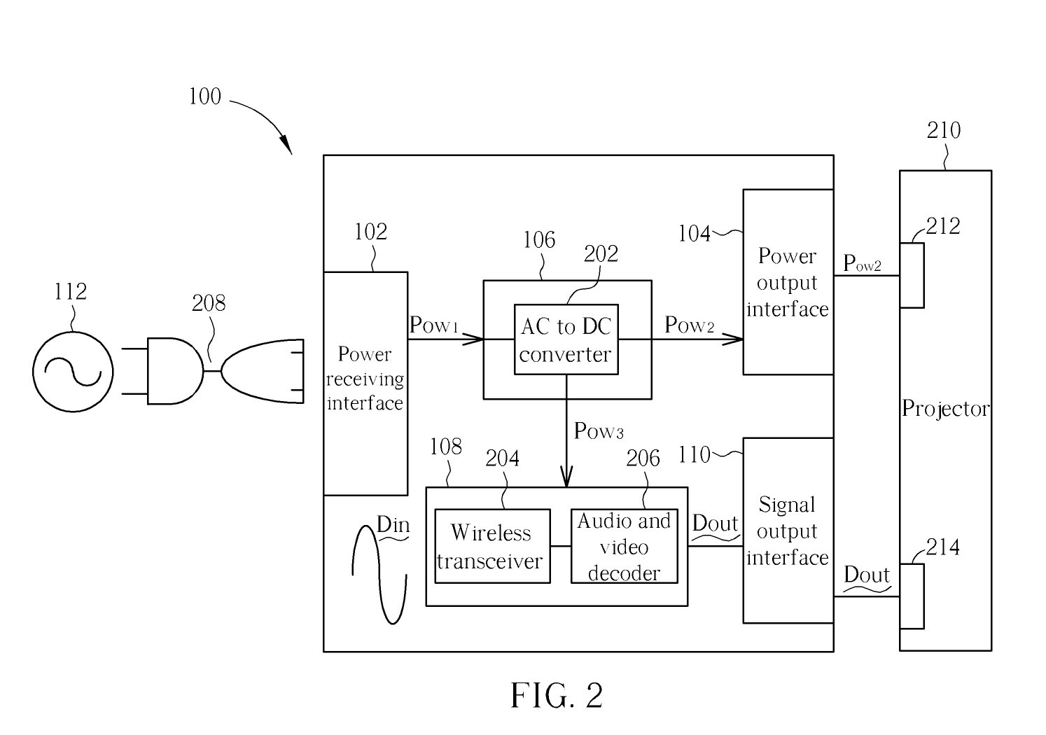

FIG. 2 is an exemplary structure of the signal transceiving apparatus shown in FIG. 1. In the embodiment shown in FIG. 2, the target electronic apparatus 114 in FIG. 1 is a projector 210. The projector 210 includes a power receiving interface 212 to receive the power Pow2, and a signal receiving interface 214 to receive the output data Dₒᵤₜ. In this embodiment, the output data Dₒᵤₜ is audio/video data. Besides, in the embodiment shown in FIG. 2, the power source 112 is a AC power source, and transmits power Pow1 to the power receiving interface 102 via the power transmitting line 208. The voltage converter 106 by-passes power Pow1 to directly form the power Pow2, and outputs the power Pow2 to the projector 210 via the power output interface 104. Besides, the voltage converter 106 includes a AC TO DC converter 202, to convert the AC power Pow1 to the DC power Pow3, to provide the power Pow3 needed by the signal transferring apparatus 108. The signal transferring apparatus 108 includes a wireless transceiver 204 to receive the input data Din. The wireless transceiver 204 can be the wireless transceiving apparatus transceiving different kinds of wireless signals such as infrared ray, Bluetooth, wireless LAN or a wireless net card utilizing a mobile phone base station. The signal transferring apparatus 108 further comprises an audio and video decoder 206, to decode the input data Dᵢₙ to generate the output data Dₒᵤₜ matching the spec of the projector 210. In one embodiment, the input data Dᵢₙ received by the wireless transceiver 204 is a RF signal, and the wireless transceiver 204 transfers it to a baseband signal. Then the audio and video decoder 206 decodes the baseband signal to generate the output data Dₒᵤₜ. It should be noted that, in the operation that the signal transceiving apparatus 100 receives and outputs the power and the data, the voltage or spec of the output data Dₒᵤₜ is not qualified enough to be the power. The above-mentioned embodiment is not limited to the structure shown in FIGS. 1 and 2, transmission with wire or without wire can be selectively utilized depending on desired function.

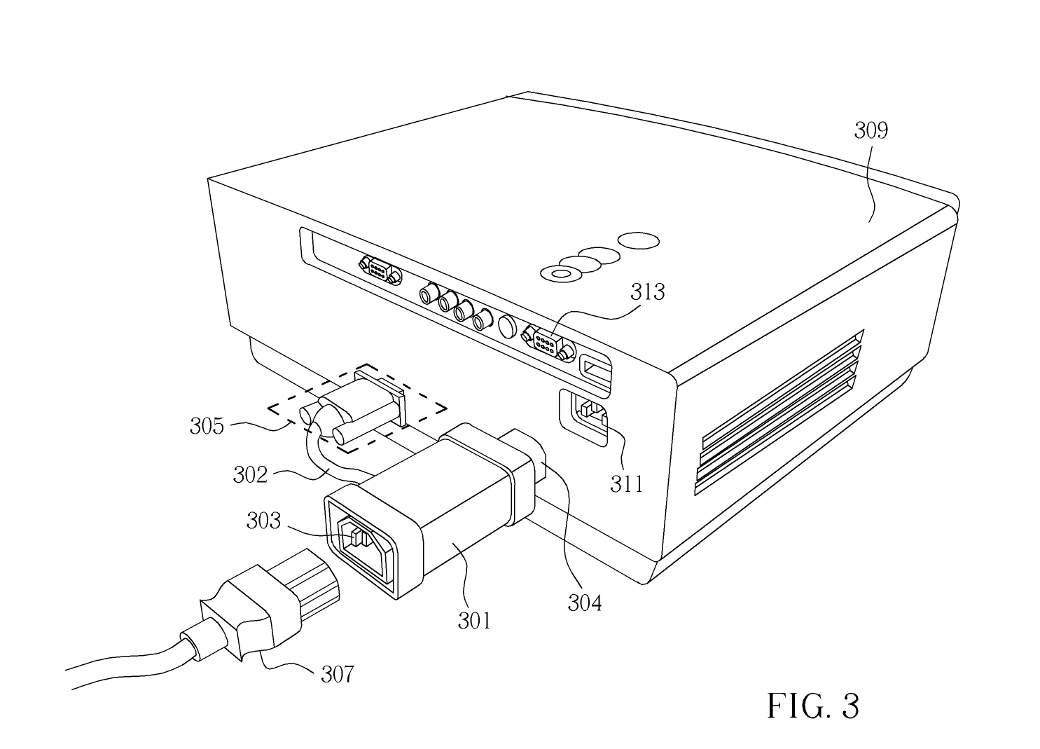

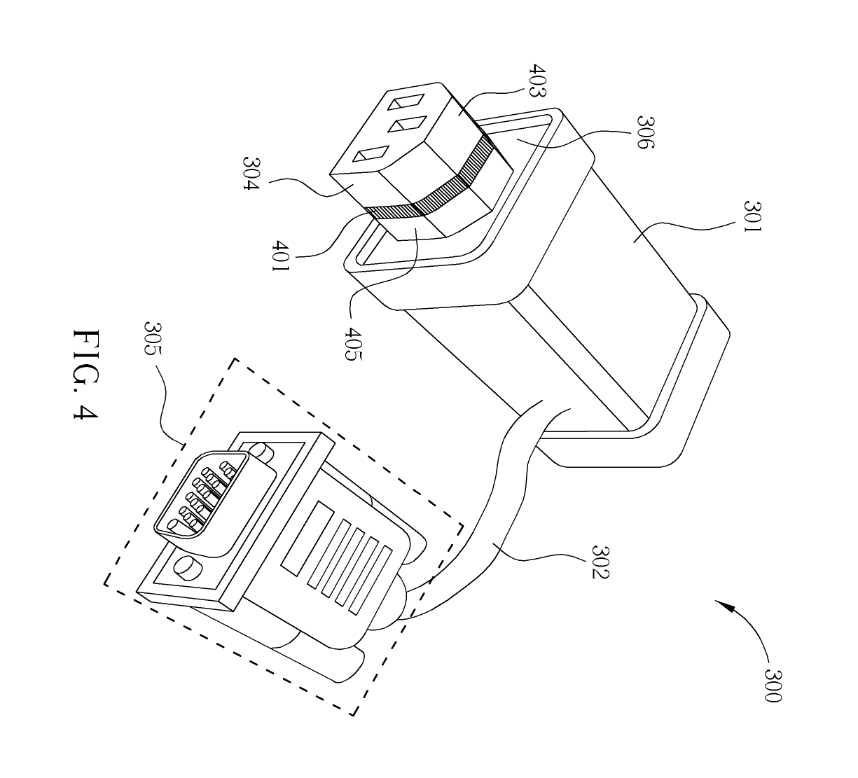

FIGS. 3 and 4 are schematic diagrams illustrating appearance of the signal transceiving apparatus and the target electronic apparatus shown in FIG. 2. Please jointly refer to FIGS. 2, 3 and 4 to under stand the relations between each device more clearly. The projector 309 in FIG. 3 corresponds to the projector 210 in FIG. 2, the video signal receiving interface 311 in FIG. 3 corresponds to the signal receiving interface 214 in FIG. 2, the power receiving interface 311 in FIG. 3 corresponds to the power receiving interface 212 in FIG. 3, and the power transmitting line 307 in FIG. 3 corresponds to the power transmitting line 208 in FIG. 2. A first body not illustrated in FIG. 3 includes a power receiving interface 303 (corresponding to 102 in FIG. 2), the power output interface 304 (corresponding to 104 of FIG. 2), and a non-illustrated AC to DC converter. The first body is surrounding by the second body 301. The second body 301 includes the signal transferring apparatus 108 shown in FIG. 2. The signal output interface 305 corresponds to the signal output interface 110 shown in FIG. 2. Accordingly, it can be understand how the embodiment shown in FIG. 2 is applied to a projector. FIG. 4 is a schematic diagram illustrating appearance of the signal transceiving apparatus shown in FIG. 2. In view of the signal receiving apparatus 300 shown in FIG. 4, the relations between the first body 306, the power output interface 304, the second body 301 and the signal output interface 305.

In the embodiments shown FIGS. 3 and 4, the operation between each device can be described as below: the first body 306 receives power from the power transmitting line 307, and outputs power to the power receiving interface 311 via the power output interface 304. The second body 301 utilizes a wireless transceiver included therein (204 in FIG. 2) to receive data (Din shown in FIG. 2). Then the second body 301 utilizes an audio/video decoder (206 shown in FIG. 2) to decode data, and outputs the decoded data to an video signal receiving interface 313 of the projector 309 via the signal output interface 305. The signal output interface 305 is connected to the second body 301 via the transmitting line 302.

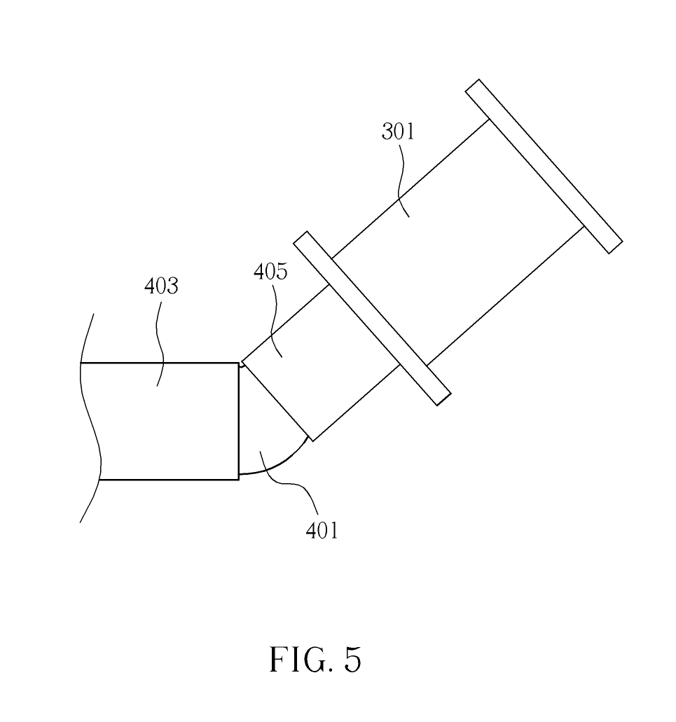

Additionally, in the embodiment shown in FIG. 4, the first body 306 can include a flexible part 401, located between a first part 403 and a second part 405 of the first body 306, such that the angle between the first part 403 and the second part 405 can be changed. By this way, the user can bend the signal transceiving apparatus 300 to any angle, as shown in FIG. 5. Via the flexible part 401, a proper angle can be formed between the power output interface 304 and the second body 301. Via this structure, a proper angle can between the power output interface 304 and the second body 301 can be adjusted responding the location of the projector (ex. hanged or located at a corner or near a wall), such that it is more convenient to connect the power output interface 304 and the power receiving interface 311.

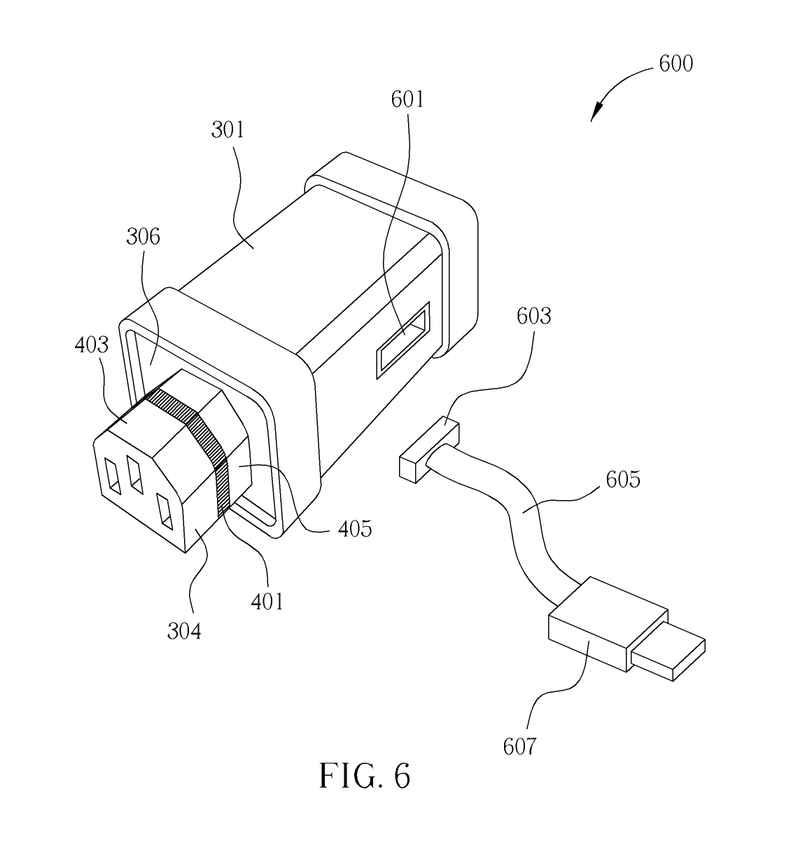

FIG. 6 is a variation example for the embodiment shown in FIGS. 3 and 4. As shown in FIG. 6, a signal output interface of the signal transceiving apparatus 600 is a socket 601 rather than a transmitting line 302 connected to the second body 301 as shown in FIGS. 3 and 4. The socket 601 can be connected to a transmitting line 605 including a transmitting interface 603 with specific spec. Also, the other end of the transmitting line 605 can include a transmitting interface 607. Furthermore, the socket 601, the transmitting interfaces 603, 607 in this embodiment can be popular interfaces such as VGA, DVI, HDMI and Ethernet. By this way, the convenience for carrying the signal transceiving apparatus 600 can further improve. Additionally, the spec of the socket 601, the transmitting interfaces 603 and 607 can be varied according to requirements, thus the convenience for transmitting data increases.

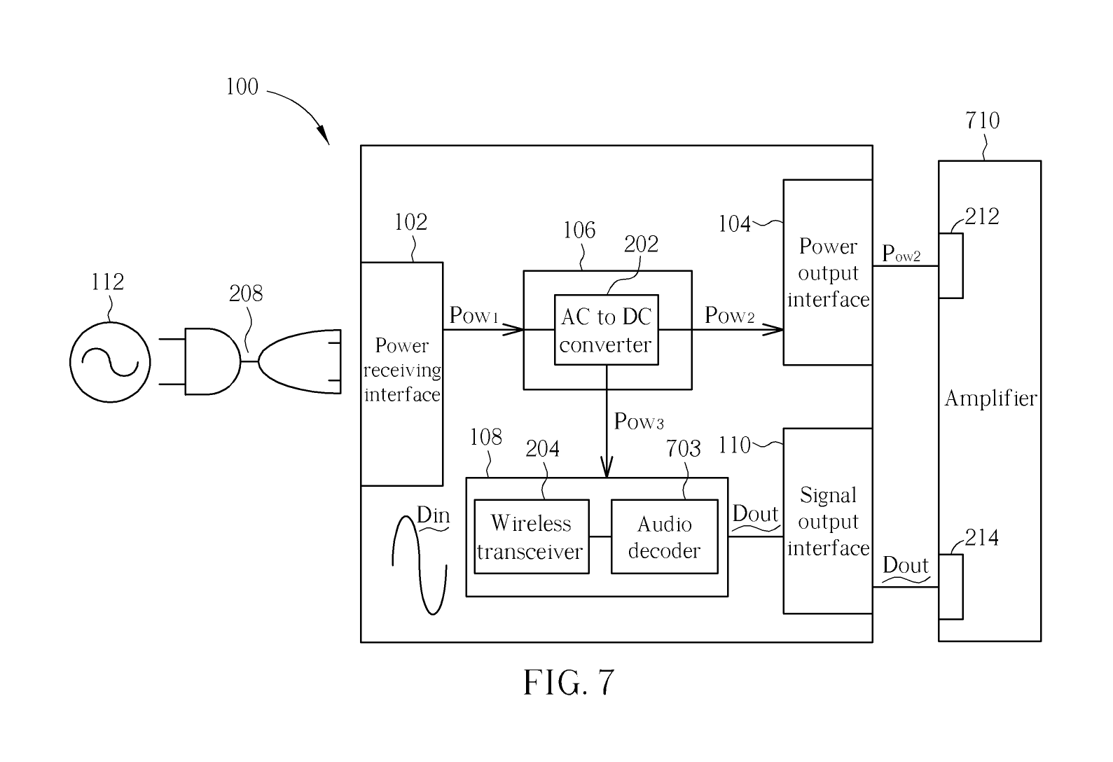

FIG. 7 is a variation example for the embodiment shown in FIG. 2. In the embodiment shown in FIG. 7, the projector 210 is replaced with an amplifier 701, which can be a loud speaker. Also, the audio and video decoder 206 is replaced with a audio decoder 703. Therefore, the signal transceiving apparatus provided by the present application is not limited to be applied to the projector or the apparatus that can display audio and video apparatus, it can also be applied to an apparatus than can display only the audio signal or the video signal, such as an amplifier.

Those skilled in the art will readily observe that numerous modifications and alterations of the device and method may be made while retaining the teachings of the invention.

What is claimed is:

1. A signal transceiving apparatus with a power provider, comprising:
a power receiving interface, for receiving a first power;
a power output interface, for outputting a second power;
a signal transferring apparatus, for receiving a third power, receiving input data and for transferring the input data to an output data matching a target electronic apparatus spec; and
a signal output interface, for outputting the output data to the target electronic apparatus; wherein the signal transforming apparatus does not provide power to the target electronic apparatus, where the second power, the third power are generated according to the first power.

2. The signal transceiving apparatus of claim 1, where the first power is an AC voltage.

3. The signal transceiving apparatus of claim 2, further comprising:
a voltage converter, for transferring the first power to the third power, wherein the voltage converter by-passes the first power to form the second power.

4. The signal transceiving apparatus of claim 3, wherein the third power is a DC voltage, where the voltage converter comprises an AC TO DC converter, for converting the first power to the third power.

5. The signal transceiving apparatus of claim 1, wherein the signal transferring apparatus receives the input data via a wire less method.

6. The signal transceiving apparatus of claim 1, wherein the target electronic apparatus is a projector.

7. The signal transceiving apparatus of claim 6, wherein the output data is a audio and video data, where the signal transferring apparatus further includes a audio and video decoder for decoding the input data to form the output data.

8. The signal transceiving apparatus of claim 1, wherein the signal transceiving apparatus does not receive power from the target electronic apparatus.

9. The signal transceiving apparatus of claim 1, wherein the target electronic apparatus is an amplifier.

10. The signal transceiving apparatus of claim 9, wherein the output data is an audio data, where the signal transferring apparatus further includes an audio decoder, for decoding the input data to form the output data.

11. A signal transceiving apparatus with a power provider, comprising:
a first body, including:
a power receiving interface, for receiving a first power; and
a power output interface, for outputting a second power;
a second body, for receiving a third power, receiving a input data and for transferring the input data to an output data matching a target electronic apparatus spec, including:
a signal output interface, for outputting the output data to the target electronic apparatus;
wherein the second body does not provide power to the target electronic apparatus, where the second power, the third power are generated according to the first power.

12. The signal transceiving apparatus of claim 11, where the first power is an AC voltage.

13. The signal transceiving apparatus of claim 12, wherein the first body further comprises:
a voltage converter, for transferring the first power to the third power, wherein the voltage converter by-passes the first power to form the second power.

14. The signal transceiving apparatus of claim 13, wherein the third power is a DC voltage, where the voltage converter comprises an AC TO DC converter, for converting the first power to the third power.

15. The signal transceiving apparatus of claim 11, wherein the second body receives the input data via a wire less method.

16. The signal transceiving apparatus of claim 11, wherein the target electronic apparatus is a projector.

17. The signal transceiving apparatus of claim 16, wherein the output data is a audio and video data, where the second body further includes a audio and video decoder for decoding the input data to form the output data.

18. The signal transceiving apparatus of claim 11, wherein the second body does not receive power from the target electronic apparatus.

19. The signal transceiving apparatus of claim 11, wherein the second body does not receive power from the target electronic apparatus.

20. The signal transceiving apparatus of claim 11, wherein the first body includes a flexible part, located between a first part and a second part of the first body, such that the angle between the first part and the second part can be changed.

21. The signal transceiving apparatus of claim 11, wherein the signal output interface is a socket located on the second body.
